(19) United States
(12) Patent Application Publication
(10) Pub. No.: US 2025/0184242 A1
(43) Pub. Date: Jun. 5, 2025

(54) AUTOMATED GENERATION AND/OR ANALYSIS OF INCIDENT TICKETS

(71) Applicant: Wells Fargo Bank, N.A., San Francisco, CA (US)

(72) Inventors: Nandana Kudeti, Vijayawada (IN); Bennett Keith Wagoner, Wilmington, NC (US); Andrew Clarence Osborn, Kimberling City, MO (US); Srinivas Ksheerasagara, Telangana (IN)

(21) Appl. No.: 18/055,071

(22) Filed: Nov. 14, 2022

(51) Int. Cl. H04L 41/5074; G06F 18/23213; G06F 18/2413; G06N 5/01; H04L 41/16

(52) U.S. Cl. CPC H04L 41/5074; G06F 18/23213; G06F 18/24137; G06N 5/01; H04L 41/16

(57) ABSTRACT

An example computer system for managing incident tickets can include: one or more processors; and non-transitory computer-readable storage media encoding instructions which, when executed by the one or more processors, causes the computer system to create: a ticket generation engine programmed to automate generation of automated incident tickets associated with issues associated with computing devices, the ticket generation engine populating a cause of an issue for each of the automated incident tickets; and a ticket management engine programmed to receive the automated incident tickets and manual incident tickets generated manually, the ticket management engine standardizing the automated incident tickets and the manual incident tickets to create clusters of the issues associated with the computing devices.

### BACKGROUND

Incident tickets, which are created when issues occur in a computer system, can be difficult to manage. Such incident tickets are typically created manually by users of the computer system. The incident tickets can include inconsistent and omitted information surrounding the incidents. This can result in longer durations to remedy the issues and difficulty in determining trends associated with the issues.

### SUMMARY

Examples provided herein are directed to the automated generation and analysis of incident tickets.

According to one aspect, an example computer system for managing incident tickets can include: one or more processors; and non-transitory computer-readable storage media encoding instructions which, when executed by the one or more processors, causes the computer system to create: a ticket generation engine programmed to automate generation of automated incident tickets associated with issues associated with computing devices, the ticket generation engine populating a cause of an issue for each of the automated incident tickets; and a ticket management engine programmed to receive the automated incident tickets and manual incident tickets generated manually, the ticket management engine standardizing the automated incident tickets and the manual incident tickets to create clusters of the issues associated with the computing devices.

According to another aspect, an example method for managing incident tickets can include: automatically generating automated incident tickets associated with issues associated with computing devices, including to populate a cause of an issue for each of the automated incident tickets; receiving the automated incident tickets and manual incident tickets generated manually; and standardizing the automated incident tickets and the manual incident tickets to create clusters of the issues associated with the computing devices.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for automating the generation and analysis of incident tickets.

FIG. 2 shows example logical components of a server device of the system of FIG. 1.

FIG. 3 shows an example method for analyzing incident tickets by the server device of FIG. 2.

FIG. 4 shows example physical components of the server device of FIG. 2.

### DETAILED DESCRIPTION

This disclosure relates to automating the generation and analysis of incident tickets.

Incident tickets are sometimes referred to as “trouble tickets” or “support tickets”. Incident tickets can be generated when issues occur with a computing system. Examples of such issues include, without limitation, data corruption, capacity exceeded, component failure, access denied, etc.

When such issues occur, incident tickets are generated to track the issues. In the examples provided herein, artificial intelligence can be used to generate the incident tickets and/or analyze the incident tickets. This is accomplished by training the artificial intelligence so that the artificial intelligence can create incident tickets with machine-generated incidents and descriptions. This results in incident tickets with consistent language and completeness, thereby allowing the issues to be addressed more quickly and trends to be more easily determined.

There can be various advantages associated with the technologies described herein. For instance, by training artificial intelligence with incident ticket examples, the artificial intelligence can learn to more efficiently identify and track issues for quicker resolution. Further, the artificial intelligence can learn to generate incident tickets, thereby further enhancing efficiencies associated with the generation, tracking, and resolution of the issues. Many other advantages are possible.

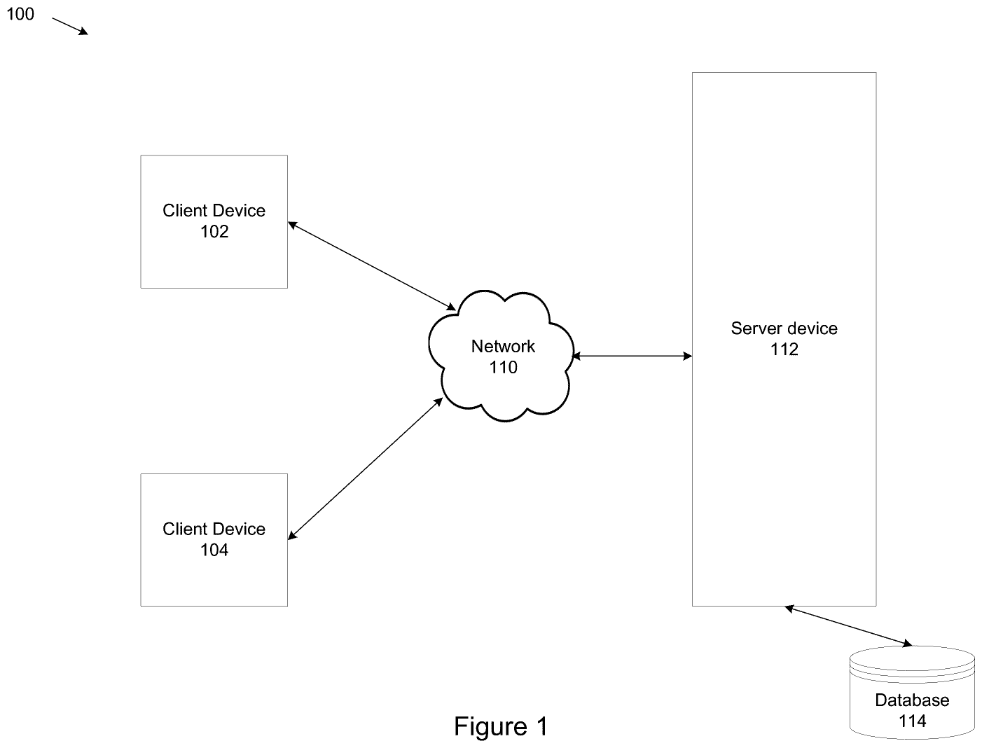

FIG. 1 schematically shows aspects of one example system 100 programmed to automate the generation and analysis of incident tickets. In this example, the system 100 can be a computing environment that includes a plurality of client and server devices. The example system 100 includes client devices 102, 104, a server device 112, and a database 114. The client devices 102, 104 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 can be programmed to communicate with the server device 112 to automate the generation and analysis of incident tickets, as described below. Many other configurations are possible.

The example client device 102 is programmed to automatically generate an incident ticket when an issue occurs with the client device 102. For example, assume the client device 102 runs out of capacity on one of the disk drives associated with the client device 102. Using the technology described herein, the client device 102 can be programmed to automatically generate an incident ticket that is sent to the server device 112 for processing. In example embodiments, the contents of the incident ticket are created through the learning of the artificial intelligence described herein.

The example client device 104 is programmed to manually generate an incident ticket when an issue occurs with the client device 104. For example, assume the client device 104 experiences a component failure for one of the peripherals associated with the client device 104. The client device 104 can be programmed to allow a user (i.e., human) of the client device 104 to manually generate an incident ticket that is sent to the server device 112 for processing. The contents of that incident ticket are manually populated by the user.

The example server device 112 is programmed to process the incident tickets received from the client devices 102, 104. As described further below, the server device 112 can be programmed to use artificial intelligence to process the incident tickets. In addition, the server device 112 can be programmed to develop a uniform process for automating the generation of incident tickets.

The example database 114 is programmed to store the incident tickets. In some examples, the server device 112 accesses the database 114 to save, retrieve, and update the incident tickets stored in the database 114. For instance, as described further below, the server device 112 can use the incident tickets stored in the database 114 to determine trends associated with the incident tickets.

The network 110 provides a wired and/or wireless connection between the client devices 102, 104 and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

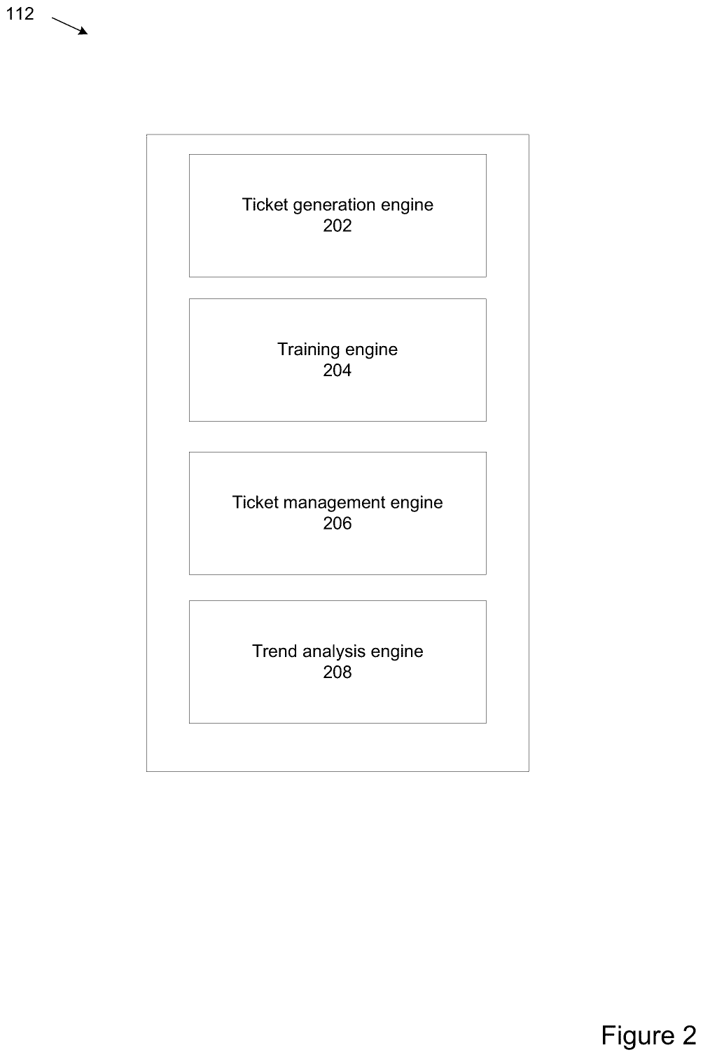

Referring now to FIG. 2, additional details of the server device 112 are shown. In this example, the server device 112 has various logical modules that assist in automating the generation and analysis of incident tickets. The server device 112 can, in this instance, include a ticket generation engine 202, a training engine 204, a ticket management engine 206, and a trend analysis engine 208. In other examples, more or fewer engines providing different functionality can be used.

The ticket generation engine 202 is programmed to use artificial intelligence to automatically generate incident tickets for issues. In these examples, the artificial intelligence-generated incident tickets can be more consistent than those that are created manually by users. This can, in most scenarios, result in incident data that is more reproducible and repeatable.

For example, an incident ticket usually includes certain information about the issue, such as a description of the issue, a cause of the issue, and a resolution for the issue. Assuming the issue of insufficient disk capacity for the client device 102, a user can use various language to describe the cause of the problem. Examples include: (i) “disk space is low”; (ii) “ran out of disk space”; (iii) “more disk space is needed”.

However, the ticket generation engine 202 is programmed to use artificial intelligence, as trained below, to automate the generation of the incident ticket for the issue associated with the client device 102. In this example, the ticket generation engine 202 uses a standardized cause for the issue, such as “insufficient disk space”. In this manner, incident tickets generated by the ticket generation engine 202 for this type of issue will be consistent. This increases the speed at which such tickets can be addressed. Further, as described further below, the consistency provides for a better trending analysis, thereby allowing systemic issues to be addressed more quickly and easily.

The example training engine 204 is programmed to train the artificial intelligence that is programmed to generate and analyze incident tickets. In such an example, the training engine 204 uses a training set of incident tickets (automatically-generated, manually-generated, or a combination thereof) to learn how to automate the generation and analysis of future incident tickets.

In this example, the training engine 204 accesses a corpus of incident tickets from the database 114. The training engine 204 takes these incident tickets and creates word vectors for them, which is a form of natural language processing of the incident tickets. In this example, the word vectors are a representation of how similar or dissimilar words are using a text analysis. In this example, the training engine 204 can use a K-means algorithm to generate the word vectors.

The training engine 204 can then conduct a centroid calculation to group similar words into a plurality of clusters. The training engine 204 is programmed to determine an optimum number of clusters using an elbow method, which is a heuristic used in determining the optimum number of clusters. The elbow method can include plotting the variation as a function of the number of clusters and picking the elbow of the curve as the number of clusters to use.

Once complete, the training engine 204 can train the artificial intelligence used by the ticket generation engine 202 to automate the generation of incident tickets. Further, the training engine 204 can train the ticket management engine 206, as described below.

The example ticket management engine 206 is programmed to receive manage incident tickets for the system 100, such as the incident tickets generated by the client devices 102, 104. In such an example, the incident tickets can be generated both automatically (e.g., by the ticket generation engine 202), as well as manually (e.g., by users of the client device 102, 104).

The ticket management engine 206 is programmed to use artificial intelligence to manage both the automated and manual tickets to arrive at a meaningful interpretation of the tickets. For instance, in the example provided above for the client device 102, the ticket management engine 206 can take a manual ticket with a cause code of “ran out of disk space” and correlate it with an automated ticket with a cause code of “insufficient disk space” so that both incident tickets are normalized, processed similarly, and trends associated with disk space issues are identified appropriately.

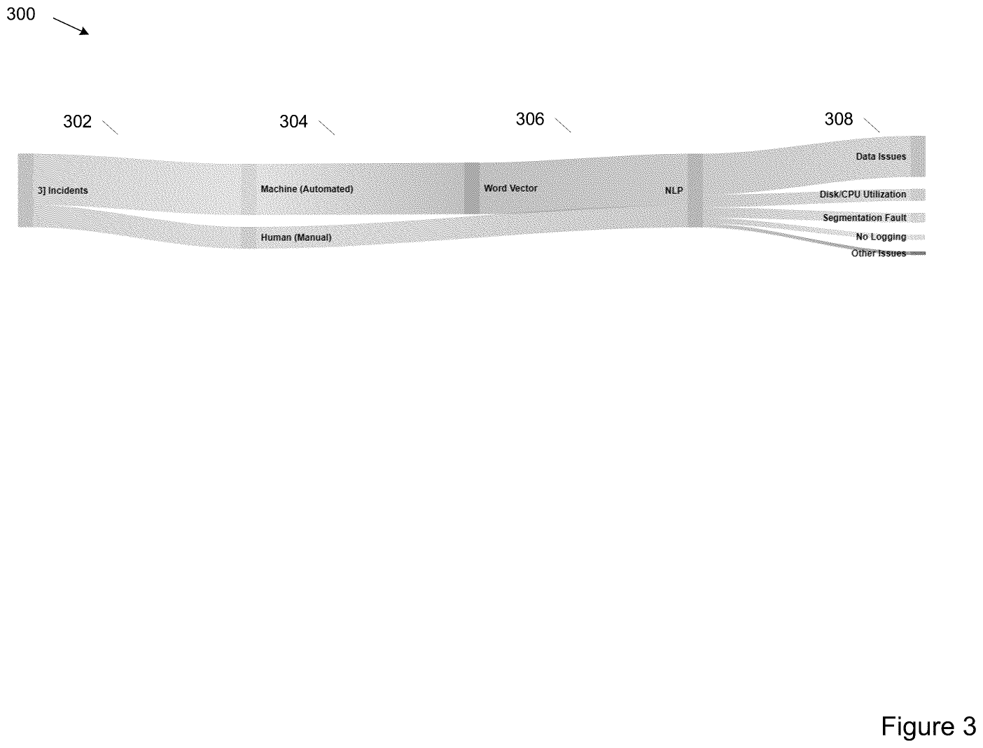

One non-limiting example of this analysis performed by the ticket management engine 206 is provided by an example method 300 shown in FIG. 3. At operation 302 of the method 300, issues occur with computing devices for the system 100, such as the examples provided above associated with the client devices 102, 104.

Next, at operation 304, incident tickets are generated for the issues. These incident tickets can be generated manually (e.g., by users) or automatically (e.g., by the ticket generation engine 202). At operation 306, the ticket management engine 206 is programmed to analysis both the manual and automated tickets using artificial intelligence (as described above), and clustering of the issues is completed at operation 308. Examples of such clusters include, without limitation: data issues; disk/CPU utilization; segmentation fault; no logging, etc.

The example trend analysis engine 208 is programmed to analyze the incident tickets received by the server device 112 and stored in the database 114 to determine trends associated with the issues identified for the computing devices of the system 100. For instance, the trend analysis engine 208 can use artificial intelligence to determine specific trends associated with the issues and determine mitigation options before issues escalate. This can include using artificial intelligence to determine “root causes” of the issues. These root causes can thereupon be analyzed to assist in proactive and reactive mitigation efforts.

Further, the trend analysis engine 208 can be programmed to revise, replace, and/or supplement the information associated with the incident tickets within the database 114. For example, the trend analysis engine 208 can use artificial intelligence to determine a standardized problem for each incident ticket and populate the problem. Similarly, the artificial intelligence can determine a standardized solution for each incident ticket and populate the solution. This results in the incident tickets within the database 114 have more standardized information that can be more easily analyzed (e.g., improving on the quality of the manual/human written problem and resolution statements).

The use of artificial intelligence in this manner can result in many of the efficiencies described herein. In addition, many other configurations are possible beyond the examples provided herein.

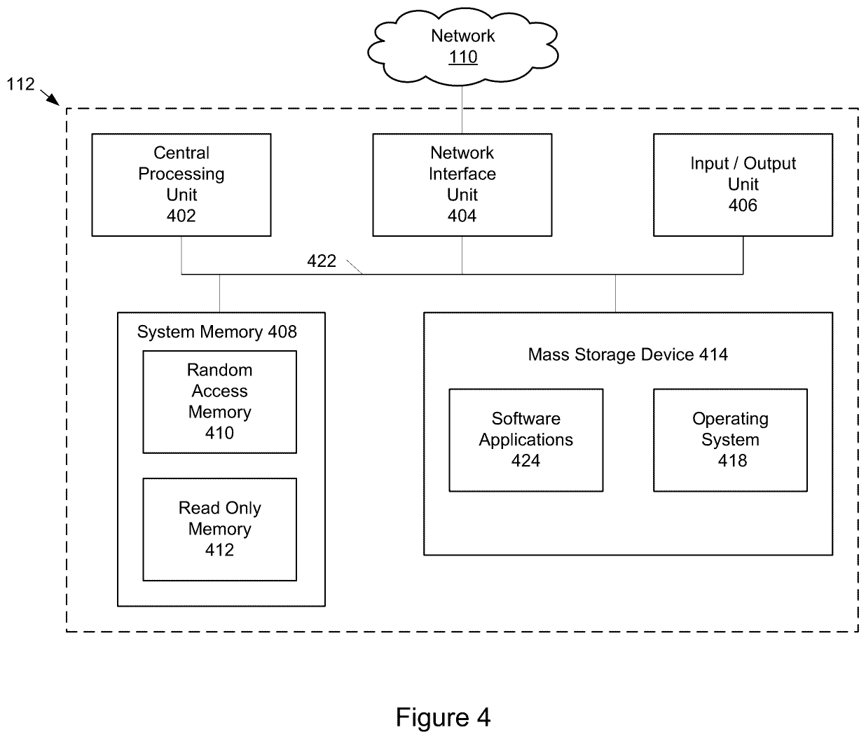

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device like that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for managing incident tickets, comprising:
one or more processors;
a database; and
non-transitory computer-readable storage media encoding instructions which, when executed by the one or more processors, causes the computer system to:
create a ticket generation engine programmed to automate generation of automated incident tickets associated with issues associated with computing devices, the ticket generation engine populating a cause of an issue for each of the automated incident tickets, wherein the ticket generation engine uses artificial intelligence to generate each of the automated incident tickets and to populate the cause of the issue for each of the automated incident tickets, the artificial intelligence used by the ticket generation engine being trained to populate one or more standardized causes for the issues of the automated incident tickets;
create a ticket management engine programmed to receive the automated incident tickets and manual incident tickets generated manually, the ticket management engine standardizing the automated incident tickets and the manual incident tickets to create clusters of the issues associated with the computing devices, the standardizing including correlating a cause code of one of the manual incident tickets with another cause code of one of the automated incident tickets;
store the incident tickets, including the automated incident tickets and the manual incident tickets, in the database; and
revise at least one of the incident tickets within the database.

2. The computer system of claim 1, wherein the manual incident tickets are configured to be generated by humans.

3-4. (canceled)

5. The computer system of claim 1, further comprising instructions which, when executed by the one or more processors, causes the computer system to create a training engine programmed to:
access a corpus of the incident tickets;
create word vectors for the corpus of the incident tickets; and
conduct a centroid calculation to group similar words into a plurality of clusters.

6. The computer system of claim 5, wherein a K-means algorithm is used to generate the word vectors.

7. The computer system of claim 5, wherein an elbow heuristic is used to determine an optimum number of the clusters.

8. The computer system of claim 1, further comprising instructions which, when executed by the one or more processors, causes the computer system to create a trend analysis engine programmed to:
analyze the incident tickets; and
determine trends associated with the issues identified for the incident tickets.

9. The computer system of claim 8, wherein the trend analysis engine is further programmed to determine a standardized problem and a standardized solution for each of the incident tickets.

10. The computer system of claim 1, wherein the database is programmed to store the automated incident tickets and the manual incident tickets.

11. A method for managing incident tickets, comprising:
automatically generating, using artificial intelligence, automated incident tickets associated with issues associated with computing devices, including to populate, using the artificial intelligence, a cause of an issue for each of the automated incident tickets, the artificial intelligence being trained to populate one or more standardized causes for the issues of the automated incident tickets;
receiving the automated incident tickets and manual incident tickets generated manually;
standardizing the automated incident tickets and the manual incident tickets to create clusters of the issues associated with the computing devices, the standardizing including correlating a cause code of one of the manual incident tickets with another cause code of one of the automated incident tickets;
storing the incident tickets, including the automated incident tickets and the manual incident tickets, in a database; and
revising at least one of the incident tickets within the database.

12. The method of claim 11, wherein the manual incident tickets are configured to be generated by humans.

13-14. (canceled)

15. The method of claim 11, further comprising:
accessing a corpus of the incident tickets;
creating word vectors for the corpus of the incident tickets; and
conducting a centroid calculation to group similar words into a plurality of clusters.

16. The method of claim 15, wherein a K-means algorithm is used to generate the word vectors.

17. The method of claim 15, wherein an elbow heuristic is used to determine an optimum number of the clusters.

18. The method of claim 11, further comprising:
analyzing the incident tickets; and
determining trends associated with the issues identified for the incident tickets.

19. The method of claim 18, further comprising determining a standardized problem and a standardized solution for each of the incident tickets.

20. The method of claim 11, further storing the automated incident tickets and the manual incident tickets in the database.
